(19) United States
(12) Patent Application Publication
(10) Pub. No.: US 2013/0165074 A1
(43) Pub. Date: Jun. 27, 2013

(54) REMOTE MONITORING SYSTEM AND METHOD

(71) Applicants: ZHONG-LIN XU, Shenzhen City (CN); XIN LU, Shenzhen City (CN); YAO-HUA LIU, Shenzhen City (CN)

(72) Inventors: ZHONG-LIN XU, Shenzhen City (CN); XIN LU, Shenzhen City (CN); YAO-HUA LIU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/434,868

(22) Filed: Mar. 30, 2012

(30) Foreign Application Priority Data
Dec. 24, 2011 (CN) 201110438357.4

(51) Int. Cl. H04W 12/08

(52) U.S. Cl. 455/411; 455/414.1

(57) ABSTRACT

A remote monitoring system includes a network server for communicating with a portable terminal, which sends a request or a remote operation command in response to an user's input. The network server includes a display device, an analyzing unit, a control unit, and a streaming media unit. The analyzing unit receives and analyzes the request to determine a request event. The streaming media unit captures an images of the real time screen of the display device in response to a command generated by the control unit, encodes the captured image, and sends the encoded image to the portable terminal The portable terminal decodes the captured image and displays the decoded image thereon. A related method is also provided.

### BACKGROUND

1. Technical Field

The present disclosure relates to network monitoring technology and, particularly, to a remote monitoring system capable of monitoring a remote computer using a mobile phone, and a method employed by the system.

2. Description of the Related Art

Most network servers can be accessed and remotely controlled by computers, not by mobile terminals. Therefore, there is room for improvement within the art to facilitate users.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic diagram of a remote monitoring system in accordance with an exemplary embodiment.

FIG. 2 is a block diagram of the remote monitoring system of FIG. 1 in accordance with an exemplary embodiment.

FIG. 3 is a flowchart illustrating a method of monitoring a network server by a portable terminal of the remote monitoring system of FIG. 1 in accordance with an exemplary embodiment.

### DETAILED DESCRIPTION

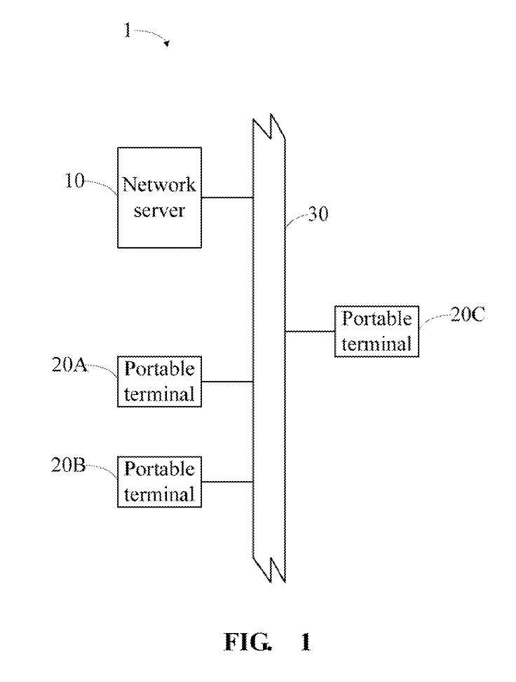

FIG. 1 is a schematic diagram of a remote monitoring system. The remote monitoring system 1 includes a network server 10 and at least one portable terminal 20. The network server 10 communicates with the portable terminals 20A-20C via a network 30. The portable terminal 20 can be a tablet computer, a smart phone, for example.

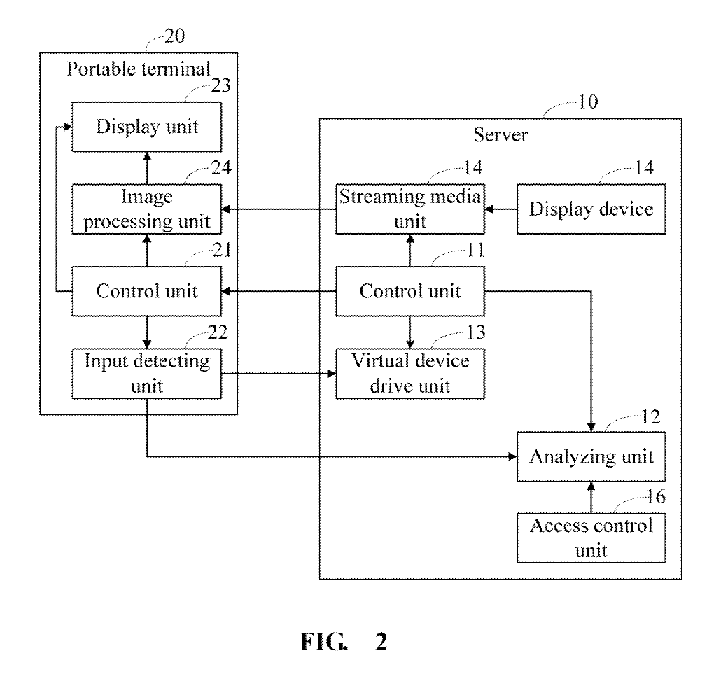

Referring to FIG. 2, the portable terminal 20 includes a control unit 21, an input detecting unit 22, a display unit 23, and an image processing unit 24. The input detecting unit 22 detects input events occurring on the portable terminal 20 and transmits the detected input event to the network server 10. The input event includes a request for accessing the network server 10 and a remote operation command in respond to an user's input. In the embodiment, the request or the remote operation command contains user information including an IP address and a user name of the portable terminal 20.

The network server 10 includes a control unit 11, an analyzing unit 12, a virtual device drive unit 13, a streaming media unit 14, and a display device 15. The analyzing unit 12 receives the request transmitted from the input detecting unit 22 of the portable terminal 20 via the network 30, and analyzes the request to determine the request event.

In the embodiment, the network server 10 further includes an access control unit 16 determining if the request or the remote operation command is sent by a user having an access permission. In the embodiment, the user of the portable terminal 20 is represented by the user information. The access permission of the portable terminal 20 is selected from the group consisting of a remote control permission for allowing the user to remotely control the network server 10 by sending the remote control command, a display permission for allowing the user to obtain the image of the real time screen by sending the request, and a deny permission.

If the access permission of the user of the portable terminal 20 is the deny permission, the portable terminal 20 cannot access the network server 10, the control unit 11 further transmits a message to the portable terminal 20 to notify the user of the portable terminal 20 that he or she is not permitted to access the network server 10. The control unit 21 of the portable terminal 20 displays the message on the display unit 23.

If the access permission of the user of the portable terminal 20 is the display permission, the control unit 11 further transmits a message to the user of the portable terminal 20 to notify the user of the portable terminal 20 that he or she is only permitted to browse web pages of the network server 10. Meanwhile, the control unit 11 commands the streaming media unit 14 to capture an image of the real time screen of the display device 15, encode the captured image, and send the encode image to the portable terminal 20 via the network 30. The image processing unit 24 of the portable terminal 20 decodes the captured image. The control unit 21 of the portable terminal 20 controls the display unit 23 to display the decode image.

If the access permission of the user of the portable terminal 20 is the remote control permission, the virtual device drive unit 13 converts the determined remote operation command into a local operation command, that is, the virtual device drive unit 13 translates the command from the portable terminal 20 to be a local command which can be recognized by the network server 10. The control unit 11 responds to the local operation command to execute function related to the local operation information. Thereby the portable terminal 10 is capable of remotely controlling the network server 10.

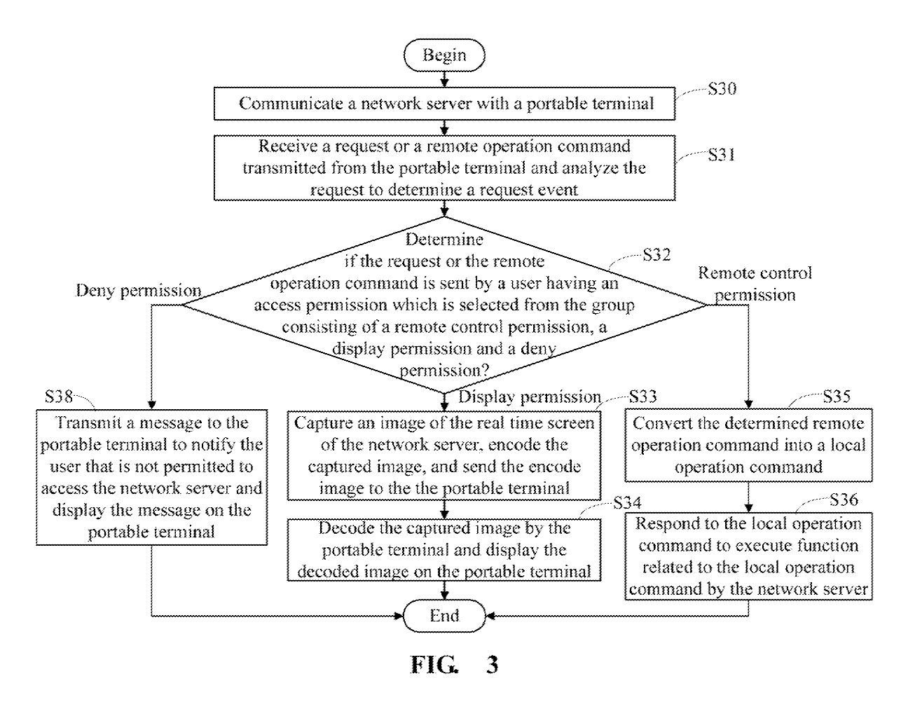

FIG. 3 a flowchart illustrating a method of remote monitoring applied in the remote monitoring system of FIG. 1.

In step S30, the portable terminal 20 communicates with the network server 10 via the network 30.

In step S31, the analyzing unit 12 receives the request or the remote operation command transmitted from the input detecting unit 22 of the portable terminal 20 via the network 30, and analyzes the request to determine the request event.

In step S32, the access control unit 16 determines the if the request or the remote operation command is sent by a user having an access permission. In the embodiment, the user of the portable terminal 20 is represented by the user information. The access permission of the portable terminal 20 is selected from the group consisting of a remote control permission for allowing the user to remotely control the network server 10 by sending the remote control command, a display permission for allowing the user to obtain the image of the real time screen by sending the request, and a deny permission. If the access permission of the user of the portable terminal 20 is the display permission, the procedure goes to step S33, if the access permission of the user of the portable terminal 20 is the remote control permission, the procedure goes to step S35, and if the access permission of the user of the portable terminal 20 is the deny permission, the procedure goes to step S37.

In the embodiment, the request or the remote operation command contains the user information including an IP address and a user name of the portable terminal 20.

In step S33, the control unit 11 commands the streaming media unit 14 to capture an image of the real time screen of the display device 15, encode the captured image, and send the encode image to the portable terminal 20 via the network 30.

In the embodiment, the control unit 11 further transmits a message to the user of the portable terminal 20 to notify the user of the portable terminal 20 that he or she is only permitted to browse web pages of the network server 10. The control unit 21 of the portable terminal 20 displays the message on the display unit 23.

In step S34, the image processing unit 24 of the portable terminal 20 decodes the captured image. The control unit 21 of the portable terminal 20 controls the display unit 23 to display the decoded image. Then, the procedure ends.

In step S35, the virtual device drive unit 13 converts the determined remote operation command into a local operation command, that is, the virtual device drive unit 13 translates a command from the portable terminal 20 to be a local command which can be recognized by the network server 10.

In step S36, the control unit 11 responds to the local operation command to execute function related to the local operation command Then, the procedure ends.

In step S37, the control unit 11 transmits a message to the portable terminal 20 to notify the user of the portable terminal 20 that he or she is not permitted to access the network server 10. The control unit 21 of the portable terminal 20 displays the message on the display unit 23.

It is understood that the present disclosure may be embodied in other forms without departing from the spirit thereof. Thus, the present examples and embodiments are to be considered in all respects as illustrative and not restrictive, and the disclosure is not to be limited to the details given herein.

1. A remote monitoring system comprising:
at least one portable terminal, each of the at least one portable terminal configured for sending a request or a remote operation command in respond to an user's input; and
a network server communicating with the at least one portable terminal via a network, wherein the network server comprising:
a display device;
an analyzing unit configured to receive and analyze the request transmitted from the portable terminal to determine a request event;
a control unit configured to generate a command according to the determined request event;
a streaming media unit configured to capture an image of a real time screen of the display device in respond to the command, encode the captured image, and send the encoded image to the portable terminal via the network, thereby the portable terminal can decode the captured image and display the decoded image on the portable terminal.

2. The remote monitoring system as recited in claim 1, wherein the network server further comprises a virtual device drive unit, the analyzing unit configured to receive and determine the remote operation command, the virtual device drive unit configured to convert the determined remote operation command into a local operation command, the control unit configured to execute the local operation command on the network server.

3. The remote monitoring system as recited in claim 2, wherein the network server further comprises an accessing control unit configured to determine if the request or the remote operation command is sent by a user having an access permission according to user information.

4. The remote monitoring system as recited in claim 3, wherein the request or the remote operation command contains the user information including an IP address and a user name of the portable terminal.

5. The remote monitoring system as recited in claim 3, wherein the access permission of user of the portable terminal is selected from the group consisting of a remote control permission for allowing the user to remotely control the network server by sending the remote control command, a display permission for allowing the user to obtain the image of the real time screen by sending the request, and a deny permission.

6. The remote monitoring system as recited in claim 5, wherein if the access permission of the user of the portable terminal is the deny permission, the control unit of the network server is configured to transmit a message to the portable terminal to notify the user of the portable terminal that such user is not permitted to access the network server.

7. A method of remote monitoring applied in a remote monitoring system, wherein the remote monitoring system comprises a network server and at least one portable terminal, the network server communicates with the at least one portable terminal via a network, the method comprising:
(1) receiving a request or a remote operation command transmitted from the portable terminal and analyzing the request transmitted from portable terminal to determine a request event;
(2) generating a command according to the determined request event; and
(3) capturing an image of a real time screen of the network server in respond to the command, encoding the captured image, and sending the encoded image to the portable terminal, whereby the encoded image can be decoded and displayed on the portable terminal.

8. The method as recited in claim 7, wherein prior to (2) further comprising:
determining whether the request or the remote operation command is sent by a user having an access permission according to user information.

9. The method as recited in claim 8, wherein the request or the remote operation command contains the user information including an IP address and a user name of the portable terminal.

10. The method as recited in claim 8, wherein the access permission of user of the portable terminal is selected from the group consisting of a remote control permission for allowing the user to remotely control the network server by sending the remote control command, a display permission for allowing the user to obtain the image of the real time screen by sending the request, and a deny permission.

11. The method as recited in claim 10, wherein the procedure of the method goes to (2) if the access permission of the user of the portable terminal is the display permission.

12. The method as recited in claim 10, wherein if the access permission of the user of the portable terminal is the remote control permission further comprising:
determining the remote operation command transmitted from the portable terminal;
converting the determined remote operation command into a local operation command; and
executing the local operation command.

13. The method as recited in claim 10, further comprising transmitting a message to the portable terminal to notify the user of the portable terminal that such user is not permitted to access the network server if the access permission of the user of the portable terminal is the deny permission.
